(19) United States
(12) Patent Application Publication
(10) Pub. No.: US 2011/0267976 A1
(43) Pub. Date: Nov. 3, 2011

(54) WIRELESS RELAY APPARATUS AND WIRELESS RELAY SYSTEM

(75) Inventors: Toshiaki Oodachi, Kanagawa (JP); Norikazu Serizawa, Kanagawa (JP); Masafumi Shiohara, Kanagawa (JP); Naoki Uchida, Kanagawa (JP); Yoshiyuki Shiozaki, Kanagawa (JP)

(73) Assignee: PANASONIC CORPORATION, Kadoma-shi, Osaka (JP)

(21) Appl. No.: 13/143,983

(22) PCT Filed: Dec. 22, 2009
(86) PCT No.: PCT/JP2009/007141

§ 371 Date: Jul. 11, 2011

(30) Foreign Application Priority Data
Jan. 23, 2009 (JP) 2009013052

(51) Int. Cl. H04W 24/00

(52) U.S. Cl. 370/252

(57) ABSTRACT

A wireless relay apparatus which can provide a wireless relay apparatus compatible with an MIMO system without changing the wiring of an already installed wireless relay apparatus or wireless relay system not compatible with the MIMO system, and which is able to minimize the costs that are generated in installing a wireless relay apparatus compatible with the MIMO system. In this apparatus, a second wireless apparatus (160) is connected to a first wireless apparatus (150) by a coaxial cable (170). The downlink signal wireless unit (111) caries out wireless processing of a downlink signal received at an antenna (102), and in this wireless processing, down-converts the downlink signal received at the antenna (102) to a frequency different than the frequency of the downlink signal received at an antenna (101). The duplexer (115) combines the downlink signal which was subjected to wireless processing at a downlink signal wireless unit (109) and the downlink signal which was subjected to wireless processing at the downlink signal wireless unit (111), and transmits the same using the same coaxial cable (170) to the second wireless apparatus (160).

### TECHNICAL FIELD

The present invention relates to a radio relay apparatus and a radio relay system, more specifically, a radio relay and a radio relay system that can support an MIMO (Multiple-Input Multiple-Output) system without changing an existing wiring.

### BACKGROUND ART

A radio relay apparatus is also called a repeater or a booster, and is an apparatus that, in order to change a radio wave dead zone area into a wireless communicable area, receives and amplifies a signal transmitted from a base station apparatus and transmits the signal into a predetermined area, and receives and amplifies a signal transmitted from a communication terminal apparatus located in the area and transmits the signal to the base station apparatus.

A conventional technique that causes a radio relay apparatus to support the MIMO and uses a plurality of transmission paths at the same frequency to obtain high-speed data transmission is known (for example, Patent Literature 1). In Patent Literature 1, antennas are connected to a plurality of radio sections. When a radio relay apparatus is applied to a system using the MIMO, a configuration shown in FIG. 7 in Patent Literature 1 needs to be employed.

### CITATION LIST

### Patent Literature

PTL 1
Japanese Patent Application Laid-Open No. 2006-197488

### SUMMARY OF INVENTION

### Technical Problem

However, in Patent Literature 1, the number of cables that transmit signals received from the antennas needs to be equal to the number of antennas. Therefore, a user who uses a radio relay apparatus that does not support the MIMO system requires an expansion for new cables when a radio relay apparatus supporting the MIMO is to be installed. Costs required for an installation operation for the radio relay apparatus disadvantageously increase. In particular, the costs for the expansion for cables are higher than the costs for purchasing the radio relay apparatus, and user' financial costs disadvantageously increase.

It is therefore an object of the present invention to make it possible to provide a radio relay apparatus that can support an MIMO system without changing wiring in an already installed radio relay apparatus or an already installed radio relay system that does not support the MIMO system and to provide a radio relay apparatus and a radio relay system that can suppress the cost of installation of a radio relay apparatus that can support the MIMO system.

### Solution to Problem

A radio relay apparatus according to the present invention includes a first radio apparatus and a second radio apparatus connected to the first radio apparatus with a first coaxial wire and relays a signal in MIMO communication by the first radio apparatus and the second radio apparatus, and the first radio apparatus employs a configuration including: a first antenna; a second antenna; a first radio section that performs first radio processing of a first signal received by the first antenna; a second radio section that performs second radio processing of a second signal received by the second antenna and converts a frequency of the second signal into a different frequency from the frequency of the first signal in the second radio processing; and a first output section that performs frequency division multiplexing of the first signal that is subjected to the first radio processing and the second signal that is subjected to the second radio processing to transmit the resulting signal to the second radio apparatus by using the first coaxial wire.

In this manner, the signal received from the first antenna and the signal received from the second antenna are made different from each other on frequency to keep independence of the signals from the antennas and to make it possible to receive/transmit two signals with one coaxial wire.

A radio relay system according to the present invention includes a radio relay apparatus having the above configuration, and at least one slave device that is connected to the radio relay apparatus with a second coaxial wire to expand a communicable area of the radio relay apparatus, and relays a signal in MIMO communication by the radio relay apparatus and the slave device, and the second radio apparatus employs a configuration that includes: a third radio section that performs third radio processing of the first signal transmitted from the first radio apparatus through the first coaxial wire and frequency conversion of the first signal in the third radio processing; a fourth radio section that performs fourth radio processing of the second signal transmitted from the first radio apparatus through the first coaxial wire and converts a frequency of the second signal into a different frequency from the frequency of the first signal that is subjected to the frequency conversion in the third radio section; and a second output section that performs frequency division multiplexing of the first signal that is subjected to the third radio processing and the second signal that is subjected to the fourth radio processing to transmit the resulting signal to the slave device through the second coaxial wire.

### Advantageous Effects of Invention

According to the present invention, a radio relay apparatus that can support an MIMO system without changing a wiring in an already installed radio relay apparatus or a radio relay system that does not support the MIMO system can be provided, and the cost of installation of a radio relay apparatus that supports the MIMO system can be suppressed.

### BRIEF DESCRIPTION OF DRAWINGS

FIG. 1 is a block diagram showing a configuration of a radio relay apparatus according to Embodiment 1 of the present invention;

FIG. 2 shows a configuration of a downlink signal radio section according to Embodiment 1 of the present invention;

FIG. 3 shows a configuration of an uplink signal radio section according to Embodiment 1 of the present invention;

FIG. 4 shows a configuration of a downlink signal radio section according to Embodiment 1 of the present invention;

FIG. 5 shows a configuration of an uplink signal radio section according to Embodiment 1 of the present invention;

FIG. 6 shows a configuration of a downlink signal radio section according to Embodiment 1 of the present invention;

FIG. 7 shows a configuration of an uplink signal radio section according to Embodiment 1 of the present invention;

FIG. 8 shows a configuration of a radio relay apparatus according to Embodiment 2 of the present invention;

FIG. 9 is a block diagram showing a configuration of a second radio apparatus and a slave device according to Embodiment 2 of the present invention;

FIG. 10 shows a configuration of a downlink signal radio section according to Embodiment 2 of the present invention;

FIG. 11 shows a configuration of an uplink signal radio section according to Embodiment 2 of the present invention;

FIG. 12 shows a configuration of a downlink signal radio section according to Embodiment 2 of the present invention; and

FIG. 13 shows a configuration of an uplink signal radio section according to Embodiment 2 of the present invention.

### DESCRIPTION OF EMBODIMENTS

Embodiments of the present invention will be described below in detail with reference to the accompanying drawings.

### Embodiment 1

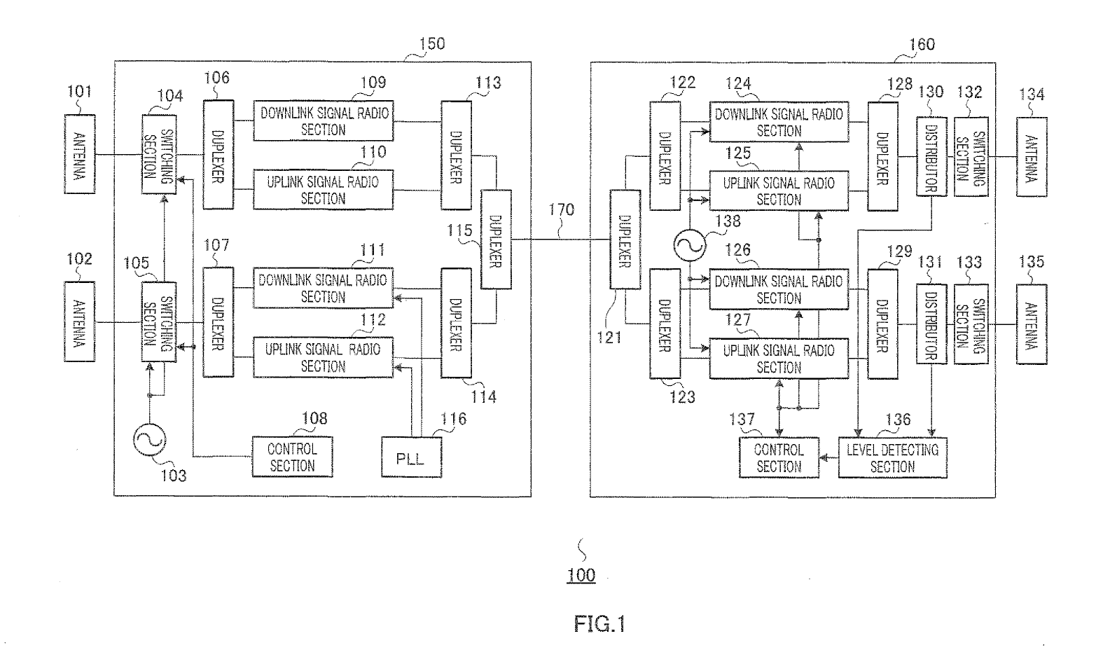

FIG. 1 is a block diagram showing a configuration of radio relay apparatus 100 according to Embodiment 1 of the present invention.

Radio relay apparatus 100 according to the embodiment is characterized by providing a radio relay apparatus that can support an MIMO system without changing a wiring in an already installed radio relay apparatus that does not support the MIMO system. Furthermore, radio relay apparatus 100 according to the embodiment is characterized to have a configuration in which signals input from antennas are not largely delayed, more specifically, a configuration in which high-frequency signals are handled without being changed in frequency not to generate a delay difference between the signals input from the antennas. Radio relay apparatus 100 in the embodiment is characterized by having a configuration in which a signal level difference is not generated between signals input from the antennas and a configuration in which a phase difference is not generated between signals (modulated waves) input from the antennas.

Radio relay apparatus 100 mainly includes first radio apparatus 150, second radio apparatus 160, and coaxial wire 170. Configurations thereof will be described below in detail.

Configurations of first radio apparatus 150 will be described first.

First radio apparatus 150 mainly includes antenna 101, antenna 102, pilot signal generating section 103, switching section 104, switching section 105, duplexer 106, duplexer 107, control section 108, downlink signal radio section 109, uplink signal radio section 110, downlink signal radio section 111, uplink signal radio section 112, duplexer 113, duplexer 114, duplexer 115, and PLL (Phase Locked Loop) circuit 116.

Antenna 101 is an antenna to perform MIMO transmission, receives a 2-GHz downlink signal transmitted from a base station apparatus (not shown), and outputs the received downlink signal to switching section 104. Antenna 101 transmits a 2-GHz uplink signal input from switching section 104 to the base station apparatus.

Antenna 102 is an antenna to perform MIMO transmission, receives a 2-GHz downlink signal transmitted from a base station apparatus (not shown) and outputs the received downlink signal to switching section 105. Antenna 102 transmits a 2-GHz uplink signal input from switching section 105 to the base station apparatus.

Pilot signal generating section 103 generates, for example, a 2-GHz pilot signal having a specific pattern to notify second radio apparatus 160 of a start of a measurement mode and outputs the generated pilot signal to switching section 104 and switching section 105. For a predetermined period of time after pilot signal generating section 103 notifies second radio apparatus 160 of the start of the measurement mode, pilot signal generating section 103 outputs a 2-GHz sine wave, and has a function of correcting the sine wave including a loss of cable 170 between first radio apparatus 150 and second radio apparatus 160 and a fluctuation of gains or the like in radio processing occurring in downlink signal radio sections 109, 111, 124, and 126.

Pilot signal generating section 103 is mounted at the position, a frequency of the signal generated by pilot signal generating section 103 is converted into a different frequency from an initial frequency through duplexer 107, downlink signal radio section 111, and duplexer 114. In this manner, in the embodiment, a pilot signal generating section other than pilot signal generating section 103 need not be mounted advantageously.

Switching section 104 switches the downlink signal input from antenna 101 and the pilot signal input from pilot signal generating section 103 to output the signals to duplexer 106. More specifically, switching section 104, when a notification of a measurement mode (described later) is received from control section 108, outputs the pilot signal input from pilot signal generating section 103 to duplexer 106. At this time, switching section 104 also plays a role of physically separating antenna 101 and pilot signal generating section 103 from each other not to transmit the pilot signal from antenna 101. Switching section 104, when a notification of an operation mode (described later) is received from control section 108, outputs the downlink signal input from antenna 101 to duplexer 106. Switching section 104 switches an output of a downlink signal input from antenna 101 or a pilot signal input from pilot signal generating section 103 to duplexer 106 and an output of an uplink signal input from duplexer 106 to antenna 101.

Switching section 105 switches a downlink signal input from antenna 102 and a pilot signal input from pilot signal generating section 103 to output the signals to duplexer 107. More specifically, switching section 105, when a notification of a measurement mode is received from control section 108, outputs the pilot signal input from pilot signal generating section 103 to duplexer 107. At this time, switching section 105 also plays a role of physically separating antenna 102 and pilot signal generating section 103 from each other not to transmit the pilot signal input from antenna 101. Switching section 105, when a notification of an operation mode is received from control section 108, outputs the downlink signal input from antenna 102 to duplexer 107. Switching section 105 switches an output of the downlink signal input from antenna 102 or the pilot signal input from pilot signal generating section 103 to duplexer 107 and an output of the uplink signal input from duplexer 107 to antenna 102.

Duplexer 106 outputs a downlink signal or a pilot signal input from switching section 104 to downlink signal radio section 109. Duplexer 106 outputs an uplink signal input from uplink signal radio section 110 to switching section 104.

Duplexer 107 outputs a downlink signal or a pilot signal input from switching section 105 to downlink signal radio section 111. Duplexer 107 outputs an uplink signal input from uplink signal radio section 112 to switching section 105.

Control section 108 determines a measurement mode and an operation mode to notify switching section 104 and switching section 105 of a determination result. For example, control section 108 has a timer to determine the measurement mode in a period of time from when radio relay apparatus 100 is started to when time T measured by the timer has elapsed. After time T has elapsed, control section 108 determines the mode as the operation mode. In this case, the measurement mode is a mode in which, in the radio relay apparatus and the radio relay system, a loss generated when a signal passes through a coaxial wire is corrected by a pilot signal, and a fluctuation caused when a signal passes through the circuits in the radio relay apparatus and the radio relay system is corrected by a pilot signal. The operation mode is a mode in which the radio relay apparatus and the radio relay system performs a normal operation that amplifies and outputs an input signal.

Downlink signal radio section 109 performs radio processing to a downlink signal or a pilot signal input from duplexer 106 to duplexer 113. More specifically, downlink signal radio section 109 amplifies the downlink signal or the pilot signal input from duplexer 106 to output the signal to duplexer 113. Downlink signal radio section 109 does not perform bandwidth limitation using a filter having significant attenuation characteristics.

Uplink signal radio section 110 performs radio processing to an uplink signal input from duplexer 113 to output the signal to duplexer 106. More specifically, uplink signal radio section 110 amplifies the uplink signal input from duplexer 113 to output the signal to duplexer 106. Uplink signal radio section 110 does not perform bandwidth limitation using a filter having significant attenuation characteristics.

Downlink signal radio section 111 performs radio processing to a downlink signal or a pilot signal input from duplexer 107 to output the signal to duplexer 114. At this time, downlink signal radio section 111, by using a clock signal input from PLL circuit 116, down-converts (frequency-converts) a 2-GHz downlink signal or a 2-GHz pilot signal into a 500-MHz downlink signal or a 500-MHz pilot signal. Details of a configuration of downlink signal radio section 111 will be described later.

Uplink signal radio section 112 performs radio processing to an uplink signal input from duplexer 114 to output the signal to duplexer 107. At this time, uplink signal radio section 112, by using a clock signal input from PLL circuit 116, up-converts (frequency-converts) a 400-MHz uplink signal into a 2-GHz uplink signal. Details of a configuration of uplink signal radio section 112 will be described later.

Duplexer 113 outputs a downlink signal or a pilot signal input from downlink signal radio section 109 to duplexer 115. Duplexer 113 outputs a downlink signal input from duplexer 115 to uplink signal radio section 110.

Duplexer 114 outputs a downlink signal or a pilot signal input from downlink signal radio section 111 to duplexer 115. Duplexer 114 outputs the uplink signal input from duplexer 115 to uplink signal radio section 112.

Duplexer 115 performs frequency division multiplexing to a downlink signal input from duplexer 113 and a downlink signal input from duplexer 114 to output the resulting signal to coaxial wire 170. Duplexer 115 performs frequency division multiplexing to a pilot signal input from duplexer 113 and a pilot signal input from duplexer 114 to output the resulting signal to coaxial wire 170. At this time, since the signal input from duplexer 113 and the signal input from duplexer 114 have frequencies of 2 GHz and 500 MHz, respectively, duplexer 115 can perform frequency division multiplexing of downlink signals or pilot signals without interfering with each other. Duplexer 115 demultiplexes the uplink signals that are input from coaxial wire 170 and subjected to frequency division multiplexing, per frequency, to output the 2-GHz uplink signal to duplexer 113 and output the 400-Mhz uplink signal to duplexer 114.

PLL circuit 116, by using a clock signal supplied from local oscillator 138 (described later) through coaxial wire 170, generates a clock signal having a predetermined frequency. PLL circuit 116 outputs the generated clock signal to downlink signal radio section 111 and uplink signal radio section 112.

Configurations of second radio apparatus 160 will be described below.

Second radio apparatus 160 mainly includes duplexer 121, duplexer 122, duplexer 123, downlink signal radio section 124, uplink signal radio section 125, downlink signal radio section 126, uplink signal radio section 127, duplexer 128, duplexer 129, distributor 130, distributor 131, switching section 132, switching section 133, antenna 134, antenna 135, level detecting section 136, control section 137, and local oscillator 138.

Duplexer 121 demultiplexes downlink signals or pilot signals that are input from coaxial wire 170 and subjected to frequency division multiplexing per frequency, outputs a 2-GHz downlink signal or a 2-GHz pilot signal to duplexer 122, and outputs a 500-MHz downlink signal or 500-MHz pilot signal to duplexer 123. Duplexer 121 performs frequency division multiplexing to the 2-HGz uplink signal input from duplexer 122 and the 400-MHz uplink signal input from duplexer 123 to output the resulting signal to coaxial wire 170.

Duplexer 122 outputs a downlink signal or a pilot signal input from duplexer 121 to downlink signal radio section 124. Duplexer 122 outputs an uplink signal input from uplink signal radio section 125 to duplexer 121.

Duplexer 123 outputs the downlink signal or the pilot signal input from duplexer 121 to downlink signal radio section 126. Duplexer 123 outputs an uplink signal input from uplink signal radio section 127 to duplexer 121.

downlink signal radio section 124 performs radio processing to a downlink signal or a pilot signal to output the resulting signal to duplexer 128. At this time, downlink signal radio section 124, by using a clock signal input from local oscillator 138, down-converts a 2-GHz downlink signal or a 2-GHz pilot signal into a 500-MHz downlink signal or a 500-MHz pilot signal and then up-converts the downlink signal or the pilot signal down-converted to 500 MHz into a 2-GHz downlink signal or a 2-GHz pilot signal. Downlink signal radio section 124, under the control of control section 137, adjusts a level of a downlink signal or a pilot signal. A detailed configuration of downlink signal radio section 124 will be described later.

Uplink signal radio section 125 performs radio processing to an uplink signal input form duplexer 128 to output the signal to duplexer 122. At this time, uplink signal radio section 125 down-converts a 2-GHz uplink signal into a 400-MHz uplink signal by using a clock signal input from local oscillator 138, and then up-converts the uplink signal down-converted to the 400-MHz signal into a 2-GHz uplink signal. Uplink signal radio section 125, under the control of control section 137, adjusts a level of the uplink signal. A detailed configuration of uplink signal radio section 125 will be described later.

Downlink signal radio section 126 performs radio processing to a downlink signal or a pilot signal input from duplexer 123 to output the signal to duplexer 129. At this time, downlink signal radio section 126 up-converts a 500-MHz downlink signal or a 500-MHz pilot signal into a 2-GHz downlink signal or a 2-GHz pilot signal by using a clock signal input from local oscillator 138. Downlink signal radio section 126, under the control of control section 137, adjusts a level of the downlink signal or the pilot signal. A detailed configuration of downlink signal radio section 126 will be described later.

Uplink signal radio section 127 performs radio processing to an uplink signal input from duplexer 129 to output the signal to duplexer 123. At this time, uplink signal radio section 127 down-converts a 2-GHz uplink signal into a 400-MHz uplink signal by using a clock signal input from local oscillator 138. Uplink signal radio section 127, under the control of control section 137, adjusts a level of the uplink signal. A detailed configuration of uplink signal radio section 127 will be described later.

Duplexer 128 outputs a downlink signal or a pilot signal input from downlink signal radio section 124 to distributor 130. Duplexer 128 outputs an uplink signal input from distributor 130 to uplink signal radio section 125.

Duplexer 129 outputs a downlink signal or a pilot signal input from downlink signal radio section 126 to distributor 131. Duplexer 129 outputs an uplink signal input from distributor 131 to uplink signal radio section 127.

Distributor 130 outputs a pilot signal input from duplexer 128 to level detecting section 136. Distributor 130 outputs a downlink signal input from duplexer 128 to switching section 132. Distributor 130 outputs an uplink signal input from switching section 132 to duplexer 128,

Distributor 131 outputs a pilot signal input from duplexer 129 to level detecting section 136. Distributor 131 outputs a downlink signal input from duplexer 129 to switching section 133. Distributor 131 outputs an uplink signal input from switching section 133 to duplexer 129.

Switching section 132 outputs a downlink signal input from distributor 130 to antenna 134. Switching section 132 outputs an uplink signal input from antenna 134 to distributor 130. Switching section 132, in the measurement mode, does not output a pilot signal input from pilot signal generating section 103 to antenna 134. With this operation, antenna 134 is physically separated.

Switching section 133 outputs a downlink signal input from distributor 131 to antenna 135. Switching section 133 outputs an uplink signal input from antenna 135 to distributor 131. Switching section 133, in the measurement mode, does not output a pilot signal from pilot signal generating section 103 to antenna 135. With the operation, antenna 135 is physically separated.

Antenna 134 is an antenna to perform MIMO transmission, and transmits a downlink signal input from switching section 132. Antenna 134 outputs a signal received from a communication terminal apparatus (not shown) in the communication area to switching section 132.

Antenna 135 is an antenna to perform MIMO transmission, and transmits a downlink signal input from switching section 133. Antenna 135 outputs a signal received from a communication terminal apparatus (not shown) in the communication area to switching section 132.

Level detecting section 136 detects a level of a pilot signal input from distributor 130 or a pilot signal input from distributor 131. Level detecting section 136 outputs a detection result of the detected level to control section 137. At this time, when level detecting section 136 detects matching between a pattern of time transient of the signal level and a known specific pattern, level detecting section 136 determines that a pilot signal is received in the measurement mode, and then detects a level within a predetermined period of time.

Control section 137, on the basis of the detection result input from level detecting section 136, adjusts a level of a signal in downlink signal radio section 124, uplink signal radio section 125, downlink signal radio section 126, or uplink signal radio section 127. More specifically, control section 137 calculates a loss of amplitude on the basis of differences between levels of pilot signals transmitted through uplink signal radio section 109 and downlink signal radio section 124 and a preset reference value to determine an adjustment value depending on the calculated loss of amplitude. Control section 137, on the basis of the determined adjustment value, performs gain control of a downlink signal in downlink signal radio section 124 and gain control of an uplink signal in uplink signal radio section 125 to adjust the level of the downlink signal in downlink signal radio section 124 and a level of the uplink signal in uplink signal radio section 125. Control section 137 calculates a loss of amplitude on the basis of differences between levels of pilot signals transmitted through downlink signal radio section 111 and downlink signal radio section 126 and a preset reference value to determine an adjustment value depending on the calculated loss of amplitude. The control section 137, on the basis of the determined adjustment value, performs gain control of a downlink signal in downlink signal radio section 126 and gain control of an uplink signal in uplink signal radio section 127 to adjust the level of the downlink signal in downlink signal radio section 126 and a level of the uplink signal in uplink signal radio section 127.

Local oscillator 138 generates a clock signal having a predetermined frequency and outputs the generated clock signal to downlink signal radio section 124, uplink signal radio section 125, downlink signal radio section 126, and uplink signal radio section 127. Local oscillator 138 transmits the generated clock signal to PLL circuit 116 through coaxial wire 170.

In this manner, local oscillator 138 supplies the generated clock to mixers of radio sections of the apparatuses in the radio relay system as reference clock to prevent frequency errors from occurring in signals input to the apparatuses in the radio relay system and signals output from the apparatuses.

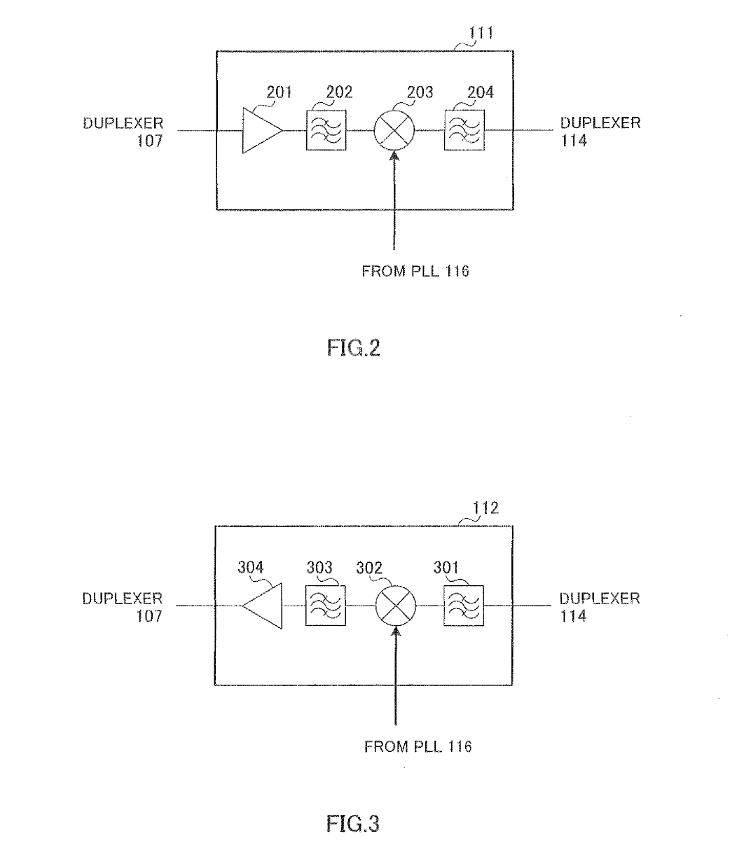

A detailed configuration of downlink signal radio section 111 will be described below with reference to FIG. 2. FIG. 2 shows a configuration of downlink signal radio section 111.

Downlink signal radio section 111 has amplifier 201, filter 202, mixer 203, and filter 204. Downlink signal radio section 111 has a configuration in which amplifier 201, filter 202, mixer 203, and filter 204 are connected in series with each other, in the order named, from the upstream side to the downstream side.

Amplifier 201 amplitudes a downlink signal or a pilot signal input from duplexer 107 to output the signal to filter 202.

Filter 202 is, for example, a saw filter or an LC filter, and limits a bandwidth of a downlink signal or a pilot signal input from amplifier 201 to output the resultant signal to mixer 203.

Mixer 203 mixes a clock signal input from PLL circuit 116 with the downlink signal or the pilot signal input from filter 202 to down-convert a 2-GHz downlink signal or a 2-GHz pilot signal into a 500-MHz downlink signal or a 500-MHz pilot signal. Mixer 203 outputs the down-converted downlink signal or the down-converted pilot signal to filter 204.

Filter 204 is, for example, a saw filter. Filter 204 is a filter having attenuation characteristics equal to or greater than a predetermined value (for example, 20 dB or more)—that is, a filter having significant attenuation characteristics—and has greater attenuation characteristics than filter 202. Consequently, filter 204 has great influence upon signal delay and phase. Therefore, filter 204 limits a bandwidth of a downlink signal or a pilot signal input from mixer 203 to output the signal to duplexer 114. In this case, the bandwidth limitation using the filter having attenuation characteristics equal to or greater than a predetermined value means a bandwidth limitation that influences signal delay and phase characteristics within a band of the signal. It is assumed that bandwidth limitation using a filter that rarely delays a signal as a filter characteristic of a CR filter or the like or bandwidth limitation using a filter in which a phase characteristic within a band of a signal rarely changes does not correspond to bandwidth limitation having attenuation characteristics equal to or greater than a predetermined value. It is assumed that bandwidth limitation using a filter such as a saw filter having a long delay time of a signal or bandwidth limitation using has significant influence on a phase characteristic of a signal corresponds to bandwidth limitation using a filter having attenuation characteristics equal to or greater than a predetermined value.

A configuration of uplink signal radio section 112 will be described below with reference to FIG. 3. FIG. 3 shows the configuration of uplink signal radio section 112.

Uplink signal radio section 112 has filter 301, mixer 302, filter 303, and amplifier 304. Uplink signal radio section 112 has a configuration in which filter 301, mixer 302, filter 303, and amplifier 304 arc connected in series with each other, in the order named, from the upstream side to the downstream side.

Filter 301 is, for example, a saw filter. Filter 301 is a filter having attenuation characteristics equal to or greater than a predetermined value (for example, 20 dB or more)—that is, a filter having significant attenuation characteristics—and has significant influence on signal delay and phase. Filter 301 limits a bandwidth of an uplink signal input from duplexer 114 to output the resultant signal to mixer 302.

Mixer 302 mixes a clock signal input from PLL circuit 116 with an uplink signal input from filter 301 to up-convert a 400-MHz uplink signal into a 2-GHz uplink signal. Mixer 302 outputs the up-converted uplink signal to filter 303.

Filter 303 is, for example, a saw filter or an LC filter, and has lower attenuation characteristics than filter 301. Filter 303 limits a bandwidth of an uplink signal input from mixer 302 to output the resultant value to amplifier 304.

Amplifier 304 amplifies an uplink signal input from filter 303 to output the signal to duplexer 107.

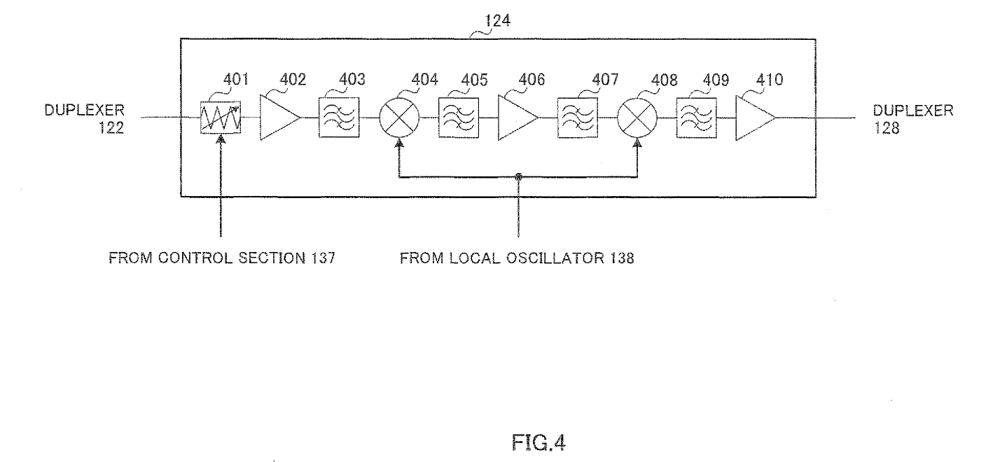

A configuration of downlink signal radio section 124 will be described below with reference to FIG. 4. FIG. 4 shows the configuration of downlink signal radio section 124.

Downlink signal radio section 124 has variable attenuator 401, amplifier 402, filter 403, mixer 404, filter 405, amplifier 406, filter 407, mixer 408, filter 409, and amplifier 410. Downlink signal radio section 124 has a configuration in which variable attenuator 401, amplifier 402, filter 403, mixer 404, filter 405, amplifier 406, mixer 407, filter 408, variable attenuator 401, amplifier 402, filter 403, mixer 404, filter 405, amplifier 406, filter 407, mixer 408, filter 409, and amplifier 410 are connected in series with each other, in the order named, from the upstream side to the downstream side.

Variable attenuator 401 attenuates the level of a downlink signal or a pilot signal input from duplexer 122 to an adjustment value determined in control section 137. Variable attenuator 401 outputs the downlink signal or a pilot signal having an attenuated level to amplifier 402.

Amplifier 402 amplifies the downlink signal or the pilot signal input from variable attenuator 401 to output the amplified signal to filter 403.

Filter 403 is, for example, a saw filter or an LC filter, and limits a bandwidth of the downlink signal or the pilot signal input from amplifier 402 to output the signal to mixer 404.

Mixer 404, based on a clock signal input from local oscillator 138, performs frequency conversion of a frequency the downlink signal or the pilot signal input from filter 403. More specifically, mixer 404 mixes the clock signal input from local oscillator 138 with the downlink signal or the pilot signal input from filter 403 to down-convert a 2-GHz downlink signal or a 2-GHz pilot signal into a 500-MHz downlink signal or a 500-MHz pilot signal. Mixer 404 outputs the down-converted downlink signal or the down-converted pilot signal to filter 405.

Filter 405 is, for example, a saw filter. Filter 405 is a filter having attenuation characteristics equal to or greater than a predetermined value (for example, 20 dB or more)—that is, a filter having significant attenuation characteristics—and has greater attenuation characteristics than filter 403. Therefore, filter 405 has significant influence upon signal delay and phase. The filter 405 limits a bandwidth of the downlink signal or the pilot signal input from mixer 404 to output the signal to amplifier 406.

Amplifier 406 amplifies the downlink signal or the pilot signal input from filter 405 to output the signal to filter 407.

Filter 407 is, for example, a saw filter. Filter 407 is a filter having attenuation characteristics equal to or greater than a predetermined value (for example, 20 dB or more)—that is, a filter having significant attenuation characteristics—and has greater attenuation characteristics than filter 403. Therefore, filter 407 has significant influence upon signal delay and phase. Filter 407 limits a bandwidth of the downlink signal or the pilot signal input from amplifier 406 to output the signal to mixer 408.

Mixer 408, based on a clock signal input from local oscillator 138, performs frequency conversion of the downlink signal or the pilot signal input from filter 407. More specifically, mixer 408 mixes the clock signal input from local oscillator 138 with the downlink signal or the pilot signal input from filter 407 to up-convert a 500-MHz downlink signal or a 500-MHz pilot signal into a 2-GHz downlink signal or a 2-GHz pilot signal. Mixer 408 outputs the down-converted downlink signal or the down-converted pilot signal to filter 409.

Filter 409 is, for example, a saw filter or an LC filter, and has lower attenuation characteristics than filter 405 and filter 407. Filter 409 limits a bandwidth of the downlink signal or the pilot signal input from mixer 408 to output the signal to amplifier 410.

Amplifier 410 amplifies the downlink signal or the pilot signal input from filter 409 to output the signal to duplexer 128.

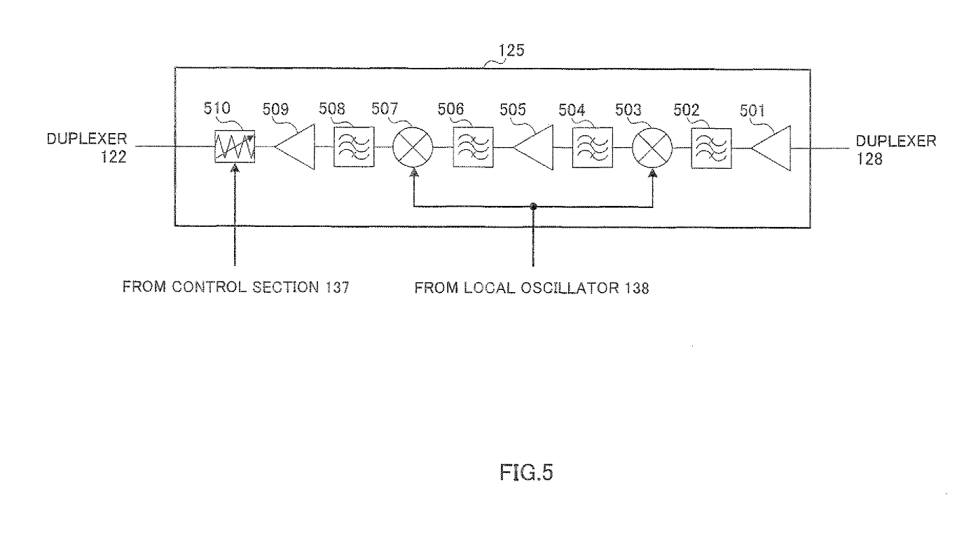

A configuration of uplink signal radio section 125 will be described below with reference to FIG. 5. FIG. 5 shows the configuration of uplink signal radio section 125.

Uplink signal radio section 125 has amplifier 501, filter 502, mixer 503, filter 504, amplifier 505, filter 506, mixer 507, filter 508, amplifier 509, and variable attenuator 510. Uplink signal radio section 125 has a configuration in which amplifier 501, filter 502, mixer 503, filter 504, amplifier 505, filter 506, mixer 507, filter 508, amplifier 509, and variable attenuator 510 are connected in series with each other from the upstream side to the downstream side.

Amplifier 501 amplifies the uplink signal input from duplexer 128 to output the signal to filter 502.

Filter 502 is, for example, a saw filter or an LC filter, and limits a bandwidth of the uplink signal input from amplifier 501 to output the signal to mixer 503.

Mixer 503, based on a clock signal input from local oscillator 138, performs frequency conversion of the uplink signal input from filter 502. More specifically, mixer 503 mixes the clock signal input from local oscillator 138 with the uplink signal input from filter 502 to down-convert a 2-GHz uplink signal into a 400-MHz uplink signal. Mixer 503 outputs the down-converted uplink signal to filter 504.

Filter 504 is, for example, a saw filter. Filter 504 is a filter having attenuation characteristics equal to or greater than a predetermined value (for example, 20 dB or more)—that is, a filter having significant attenuation characteristics—and has greater attenuation characteristics than filter 502. Therefore, filter 504 has significant influence upon signal delay and phase. Filter 504 limits a bandwidth of the uplink signal input from mixer 503 to output the signal to amplifier 505.

Amplifier 505 amplifies an uplink signal input from filter 504 to output the signal to filter 506.

Filter 506 is, for example, a saw filter. Filter 506 is a filter having attenuation characteristics equal to or greater than a predetermined value (for example, 20 dB or more)—that is, a filter having significant attenuation characteristics—and has greater attenuation characteristics than filter 502. Therefore, filter 506 has significant influence upon signal delay and phase. Filter 506 limits a bandwidth of the uplink signal input from mixer 505 to output the signal to amplifier 507.

Mixer 507, based on a clock signal input from local oscillator 138, performs frequency conversion of the uplink signal input from filter 506. More specifically, mixer 507 mixes the clock signal input from local oscillator 138 with the uplink signal input from filter 506 to up-convert a 400-MHz uplink signal into a 2-GHz uplink signal. Mixer 507 outputs the up-converted uplink signal to filter 508.

Filter 508 is, for example, a saw filter or an LC filter, and has lower attenuation characteristics than filter 504 and filter 506. Filter 508 limits a bandwidth of the uplink signal input from mixer 507 to output the signal to amplifier 509.

Amplifier 509 amplifies the uplink signal input from filter 508 to output the signal to variable attenuator 510.

Variable attenuator 510 attenuates the level of an uplink signal input from amplifier 509 to an adjustment value determined in control section 137. Variable attenuator 510 outputs the uplink signal having an attenuated level to duplexer 122.

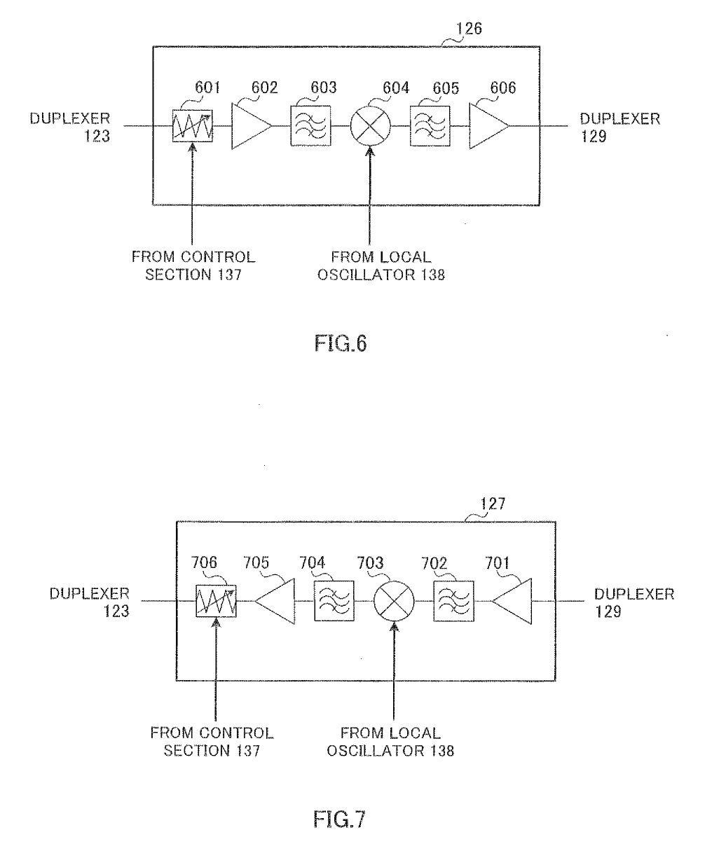

A configuration of downlink signal radio section 126 will be described with reference to FIG. 6. FIG. 6 shows the configuration of downlink signal radio section 126.

Downlink signal radio section 126 has variable attenuator 601, amplifier 602, filter 603, mixer 604, filter 605, and amplifier 606. Downlink signal radio section 126 has a configuration in which variable attenuator 601, amplifier 602, filter 603, mixer 604, filter 605, and amplifier 606 are connected in series with each other, in the order named, from the upstream side to the downstream side.

Variable attenuator 601 attenuates the level of a downlink signal or a pilot signal input from duplexer 123 to an adjustment value determined in control section 137. Variable attenuator 601 outputs the downlink signal or the pilot signal, the level of which being attenuated, to amplifier 602.

Amplifier 602 amplifies the downlink signal or the pilot signal input from variable attenuator 601 to output the signal to filter 603.

Filter 603 is, for example, a saw filter. Filter 603 is a filter having attenuation characteristics equal to or greater than a predetermined value (for example, 20 dB or more)—that is, a filter having significant attenuation characteristics—and has significant influence on signal delay and phase. Filter 603 limits a bandwidth of the downlink signal or the pilot signal input from amplifier 602 to output the signal to mixer 604.

Mixer 604, based on a clock signal input from local oscillator 138, performs frequency conversion of the downlink signal input from filter 603. More specifically, mixer 604 mixes the clock signal input from local oscillator 138 with the downlink signal or the pilot signal input from filter 603 to up-convert a 500-MHz downlink signal or a 500-MHz pilot signal into a 2-GHz downlink signal or a 2-GHz pilot signal. Mixer 604 outputs the up-converted downlink signal or the up-converted pilot signal to filter 605.

Filter 605 is, for example, a saw filter or an LC filter, and has lower attenuation characteristics than filter 603. Filter 605 limits a bandwidth of the downlink signal or the pilot signal input from mixer 604 to output the signal to amplifier 606.

Amplifier 606 amplifies the downlink signal or the pilot signal input from filter 605 to output the signal to duplexer 129.

A configuration of uplink signal radio section 127 will be described below with reference to FIG. 7. FIG. 7 shows a configuration of uplink signal radio section 127.

Uplink signal radio section 127 has amplifier 701, filter 702, mixer 703, filter 704, amplifier 705, and variable attenuator 706. Uplink signal radio section 127 has a configuration in which amplifier 701, filter 702, mixer 703, filter 704, amplifier 705, and variable attenuator 706 are connected in series with each other, in the order named, from the upstream side to the downstream side.

Amplifier 701 amplifies an uplink signal input from duplexer 129 to output the signal to filter 702.

Filter 702 is, for example, a saw filter or an LC filter, and limits a bandwidth of the uplink signal input from amplifier 701 to output the signal mixer 703.

Mixer 703, based on a clock signal input from local oscillator 138, performs frequency conversion of the uplink signal input from filter 702. More specifically, mixer 703 mixes the clock signal input from local oscillator 138 with the uplink signal input from filter 702 to down-convert a 2-GHz uplink signal into a 400-MHz uplink signal. Mixer 703 outputs the down-converted uplink signal to filter 704.

Filter 704 is, for example, a saw filter. Filter 704 is a filter having attenuation characteristics equal to or greater than a predetermined value (for example, 20 dB or more)—that is, a filter having significant attenuation characteristics—and has greater attenuation characteristics than filter 702. Therefore, filter 704 has significant influence upon signal delay and phase compared to filter 702. The filter 704 limits a bandwidth of the uplink signal input from mixer 703 to output the signal to amplifier 705.

Amplifier 705 amplifies the uplink signal input from filter 704 to output the signal to variable attenuator 706.

Variable attenuator 706 attenuates the level of an uplink signal input from amplifier 705 to an adjustment value determined in control section 137. Variable attenuator 706 outputs the uplink signal, the level of which being attenuated, to duplexer 123.

As described above, a signal received by antenna 101 is subjected to bandwidth limitation twice in filter 405 and in filter 407 each having significant attenuation characteristics, and a signal received by antenna 102 is subjected to bandwidth limitation twice in filter 204 and in filter 603 each having significant attenuation characteristics. Therefore, the signal received by antenna 101 and the signal received by antenna 102 are subjected to bandwidth limitation the same number of times in the filters each having significant attenuation characteristics. An uplink signal is also subjected to bandwidth limitation the same number of times in filters each having significant attenuation characteristics. In the embodiment, the number of times of transmission of the signals received by the two antennas through filters each having significant attenuation characteristics is set to two. However, when the numbers of times of transmission of the signals received by the two antennas through the filters each having significant attenuation characteristics are arbitrarily set to the same number. In the embodiment, as the filters each having significant attenuation characteristics, the same filters are used. Delays and phase characteristics in the filters are matched with each other to make it possible to output the signals received by the two antennas from an apparatus having a filter having the same bandwidth limitation configuration.

Radio relay apparatus 100 having the above configuration, in order to provide a radio relay apparatus that can support an MIMO system without changing a wiring of an already installed radio relay apparatus that does not support the MIMO system, includes a configuration in which a frequency of a signal received by antenna 102 is converted into a different frequency from the frequency of a signal received by antenna 101 to multiplex the frequency of the signal received by antenna 101 and the frequency of the signal received by antenna 102. Radio relay apparatus 100, in order to prevent signals input from the antennas from being considerably delayed and to prevent a delay difference from being generated between the signals input from the antennas, includes a configuration in which high-frequency signals input from the antennas are processed without being changed in frequency. Radio relay apparatus 100, in order to prevent a difference delay from being generated between the signals input from the antennas, includes a configuration in which a filter that considerably delays the signals received by the plurality of antennas at high frequencies—that is, a filter having significant attenuation characteristics—is configured by a filter of one type, and the signals are subjected to bandwidth limitation the same number of times in the filter. Radio relay apparatus 100, in order to prevent a signal level difference between the signals input from the antennas, includes a configuration including a variable attenuator. Radio relay apparatus 100, in order to prevent a phase difference between the signals (modulated waves) input from the antennas, includes a configuration in which a filter that causes a large delay and has significant attenuation characteristics is configured by a filter of one type, and the signals are subjected to bandwidth limitation the same number of times in the filter having significant attenuation characteristics.

In this manner, according to the embodiment, a radio relay apparatus that can support the MIMO system can be provided without changing a wiring in an already installed radio relay apparatus that does not support the MIMO system, and the cost of installing the radio relay apparatus that can support the MIMO system can be suppressed. According to the embodiment, when a pilot signal is supplied to a switching section arranged immediately below an antenna of a first radio apparatus to adjust a level, amplitude attenuations by processes subsequent to the process for a portion immediately below the antenna arranged in the first radio apparatus can be adjusted at once in the second radio apparatus. For this reason, an adjusting operation can be simplified, and independent adjusting circuits need not be arranged in the apparatuses. Therefore, a circuit scale can be reduced. According to the embodiment, after a down-converted signal is subjected to bandwidth limitation in a filter, the signal is frequency-multiplexed with a signal that is not down-converted and transmitted to make it possible to directly transmit the signal down-converted to be subjected to bandwidth limitation through a coaxial wire. In this manner, a dedicated circuit to frequency-multiplex and output a plurality of signals need not be used, a radio relay apparatus that can support the MIMO system can be provided without increasing manufacturing costs and a circuit scale. According to the present invention, when signals received by a plurality of antennas are subjected to bandwidth limitation the same number of times in a filter having significant attenuation characteristics, a long delay time between signals can be prevented from being generated between the signals, a large phase difference can be prevented from being generated between the signals, and a signal of the MIMO system can be prevented from being deteriorated when the signal is relayed.

### Embodiment 2

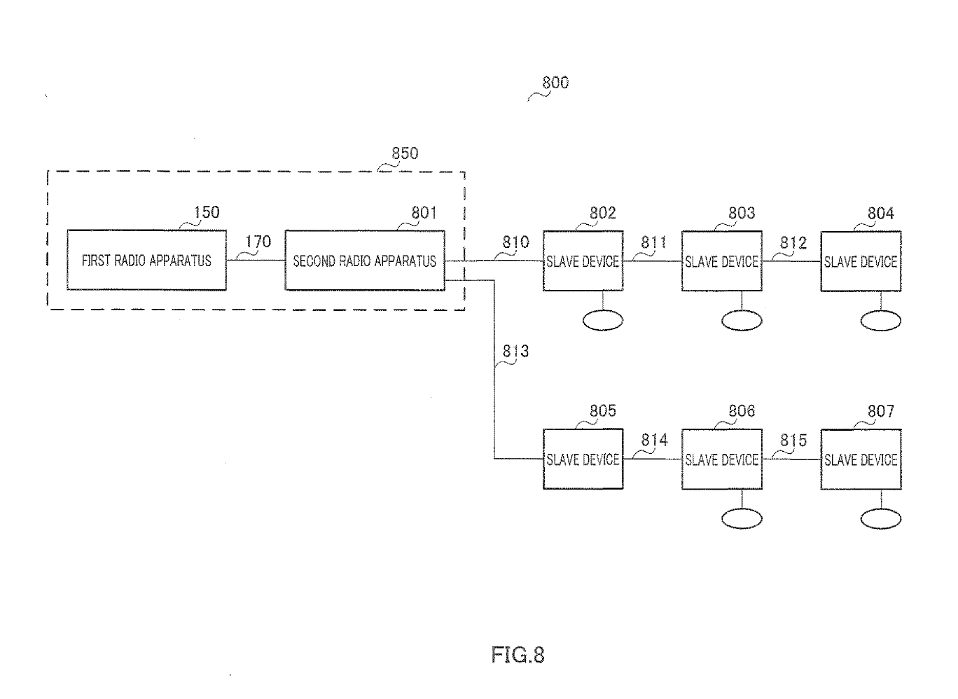

FIG. 8 shows a configuration of radio relay system 800 according to Embodiment 2 of the present invention.

Radio relay apparatus 850 shown in FIG. 8 is obtained such that second receiving apparatus 801 is arranged in place of second receiving apparatus 160 in radio relay apparatus 100 according to Embodiment 1 shown in FIG. 1. The same reference numerals as in FIG. 1 denote the same parts in FIG. 8, and their descriptions will not be repeated.

Radio relay system 800 according to the embodiment is characterized by providing a radio relay system that can support an MIMO system without changing a wiring in an already installed radio relay system that does not support the MIMO system. Radio relay system 800 is characterized by having a configuration in which signals input from antennas are not considerably delayed. Radio relay system 800 is characterized by having a configuration in which a delay difference between the signals input from the antennas. Radio relay system 800 is characterized by having a configuration in which a signal level difference between the signals input from the antennas. Radio relay system 800 is characterized by having a configuration in which a phase difference is not generated between the signals (modulated waves) input from the antennas.

Radio relay system 800 mainly includes first radio apparatus 150, second radio apparatus 801, and slave devices 802 to 807. The number of slave devices connected to second radio apparatus 801 can be arbitrarily set depending on expanded communicable areas.

Second radio apparatus 801 is connected to first radio apparatus 150 with coaxial wire 170. Second radio apparatus 801 is connected to slave device 802 with coaxial wire 810 and connected to slave device 805 with coaxial wire 813. Second radio apparatus 801 performs predetermined radio processing to a downlink signal or a pilot signal transmitted from first radio apparatus 150 through coaxial wire 170 and then transmits the signal to slave device 802 through coaxial wire 810 and transmits the signal to slave device 805 through coaxial wire 813. Second radio apparatus 801 performs predetermined radio processing to an uplink signal transmitted from slave device 802 through coaxial wire 810 or an uplink signal transmitted from slave device 805 through coaxial wire 813 and then transmits the signal to first radio apparatus 150 through coaxial wire 170.

Slave device 802 is connected to slave device 803 through coaxial wire 811. Slave device 802 performs predetermined radio processing to a downlink signal or a pilot signal transmitted from second radio apparatus 801 through coaxial wire 810 and then transmits the signal to slave device 803 through coaxial wire 811. Slave device 802 performs predetermined radio processing to an uplink signal transmitted from slave device 803 through coaxial wire 811 and then transmits the signal to second radio apparatus 801 through coaxial wire 810.

Slave device 803 is connected to slave device 804 through coaxial wire 812. Slave device 803 performs predetermined radio processing to a downlink signal or a pilot signal transmitted from slave device 802 through coaxial wire 811 and then transmits the downlink signal or the pilot signal that is subjected to the radio processing to slave device 804 through coaxial wire 812. Slave device 803 performs predetermined radio processing to an uplink signal transmitted from slave device 804 through coaxial wire 812 and then transmits the uplink signal that is subjected to the radio processing to slave device 802 through coaxial wire 811.

Slave device 805 is connected to slave device 806 through coaxial wire 814. Since processing for the signals in slave device 805 is the same as the processing for the signals in slave device 802, a description thereof will be omitted.

Slave device 806 is connected to slave device 807 through coaxial wire 815. Since processing for the signals in slave device 806 is the same as the processing for the signals in slave device 803, a description thereof will be omitted.

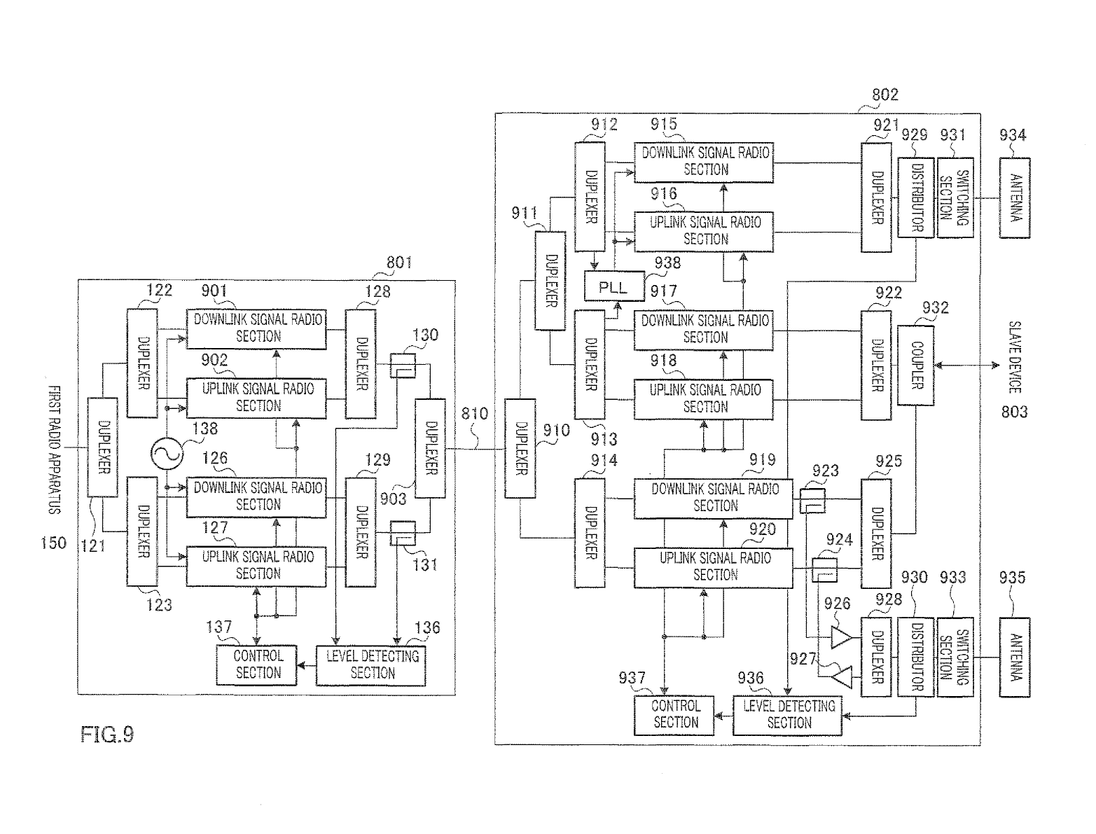

Configurations of second radio apparatus 801 and slave device 802 will be described below with reference to FIG. 9.

First, the configuration of second radio apparatus 801 will be described.

Second radio apparatus 801 shown in FIG. 9 is obtained such that, in second radio apparatus 160 according to Embodiment 1 shown in FIG. 1, switching section 132, switching section 133, antenna 134, and antenna 135 are removed, and duplexer 903 is added, downlink signal radio section 901 is arranged in place of downlink signal radio section 124, and uplink signal radio section 902 is arranged in place of uplink signal radio section 125. The same reference numerals as in FIG. 1 denote the same parts in FIG. 9, and their descriptions will not be repeated.

Second radio apparatus 801 mainly includes duplexer 121, duplexer 122, duplexer 123, downlink signal radio section 126, uplink signal radio section 127, duplexer 128, duplexer 129, distributor 130, distributor 131, level detecting section 136, control section 137, local oscillator 138, downlink signal radio section 901, uplink signal radio section 902, and duplexer 903.

Duplexer 122 outputs a downlink signal or a pilot signal input from duplexer 121 to downlink signal radio section 901. Duplexer 122 outputs an uplink signal input from uplink signal radio section 902 to duplexer 121.

Downlink signal radio section 901 performs radio processing to the downlink signal or pilot signal and outputs them to duplexer 128. At this time, downlink signal radio section 901, by using a clock signal input from local oscillator 138, down-converts a 2-GHz downlink signal or a 2-GHz pilot signal into a 500-MHz downlink signal or a 500-MHz pilot signal. Downlink signal radio section 901, under the control of control section 137, adjusts a level of the downlink signal or the pilot signal. A detailed configuration of downlink signal radio section 901 will be described later.

Uplink signal radio section 902 performs radio processing to an uplink signal input from duplexer 128 to output the signal to duplexer 122. At this time, uplink signal radio section 902, by using a clock signal input from local oscillator 138, up-converts a 400-MHz uplink signal into a 2-GHz uplink signal. Uplink signal radio section 902, under the control of control section 137, adjusts a level of the uplink signal. A detailed configuration of uplink signal radio section 902 will be described later.

Duplexer 128 outputs the downlink signal or the pilot signal input from downlink signal radio section 901 to distributor 130. Duplexer 128 outputs an uplink signal input from distributor 130 to uplink signal radio section 902.

Distributor 130 outputs the pilot signal input from duplexer 128 to level detecting section 136. Distributor 130 outputs the downlink signal or the pilot signal input from duplexer 128 to duplexer 903. Distributor 130 outputs the uplink signal input from duplexer 903 to duplexer 128.

Distributor 131 outputs a pilot signal input from duplexer 129 to level detecting section 136. Distributor 131 outputs a downlink signal or the pilot signal input from duplexer 129 to duplexer 903. Distributor 131 outputs the uplink signal input from duplexer 903 to duplexer 129.

Control section 137, on the basis of a detection result input from level detecting section 136, adjusts a level of the signal in downlink signal radio section 901, uplink signal radio section 902, downlink signal radio section 126, or uplink signal radio section 127. More specifically, control section 137 calculates a loss of amplitude on the basis of differences between levels of pilot signals transmitted through downlink signal radio section 109 and downlink signal radio section 901 and a preset reference value to determine an adjustment value depending on the calculated loss of amplitude. Control section 137, on the basis of the determined adjustment value, performs gain control of a downlink signal in downlink signal radio section 901 and gain control of an uplink signal in uplink signal radio section 902 to adjust the level of the downlink signal in downlink signal radio section 901 and a level of the uplink signal in uplink signal radio section 902. Control section 137 calculates a loss of amplitude on the basis of differences between levels of pilot signals transmitted through downlink signal radio section 111 and downlink signal radio section 126 and a preset reference value to determine an adjustment value depending on the calculated loss of amplitude. The control section 137, on the basis of the determined adjustment value, performs gain control of a downlink signal in downlink signal radio section 126 and gain control of an uplink signal in uplink signal radio section 127 to adjust the level of the downlink signal in downlink signal radio section 126 and a level of the uplink signal in uplink signal radio section 127.

Local oscillator 138 generates a clock signal having a predetermined frequency and outputs the generated clock signal to downlink signal radio section 901, uplink signal radio section 902, downlink signal radio section 126, and uplink signal radio section 127. Local oscillator 138 transmits the generated clock signal to PLL circuit 938 through coaxial wire 810.

Duplexer 903 frequency-multiplexes the downlink signal or the pilot signal input from distributor 130 with the downlink signal or the pilot signal input from distributor 131 to output the resultant signal to coaxial wire 810. Duplexer 903 frequency-multiplexes the pilot signal input from distributor 130 and the pilot signal input from distributor 131 to output the resultant signal to coaxial wire 810. At this time, since the signal input from distributor 130 and the signal input from distributor 131 have a frequency of 500 MHz and a frequency of 2 GHz, respectively, duplexer 903 can frequency-multiplex the downlink signals or the pilot signals without being interfered. Duplexer 903 demultiplexes the frequency-multiplexed uplink signals input from coaxial wire 810 per frequency, outputs a 400-MHz uplink signal to distributor 130, and outputs a 2-GHz uplink signal to distributor 131.

A configuration of slave device 802 will be described below.

Slave device 802 mainly includes duplexer 910, duplexer 911, duplexer 912, duplexer 913, duplexer 914, downlink signal radio section 915, uplink signal radio section 916, downlink signal radio section 917, uplink signal radio section 918, downlink signal radio section 919, uplink signal radio section 920, duplexer 921, duplexer 922, distributor 923, distributor 924, duplexer 925, amplifier 926, amplifier 927, duplexer 928, distributor 929, distributor 930, switching section 931, coupler 932, switching unit 933, antenna 934, antenna 935, level detecting section 936, control unit 937, and PLL circuit 938.

Duplexer 910 demultiplexes frequency-multiplexed downlink signals or frequency-multiplexed pilot signals input from coaxial wire 810 per frequency, outputs a 500-MHz downlink signal or a 500-MHz pilot signal to duplexer 911, and outputs a 2-GHz downlink signal or a 2-GHz pilot signal to duplexer 914. Duplexer 910 frequency-multiplexes a 400-MHz uplink signal input from duplexer 911 and a 2-GHz uplink signal input from duplexer 914 to output the resultant signal to coaxial wire 810.

Duplexer 911 distributes the downlink signal or the pilot signal input from duplexer 910 to duplexer 912 and duplexer 913. Duplexer 911 multiplexes the uplink signal input from duplexer 912 and the uplink signal input from duplexer 913 to output the resultant signal to duplexer 910.

Duplexer 912 outputs the downlink signal or the pilot signal input from duplexer 911 to downlink signal radio section 915. Duplexer 912 outputs an uplink signal input from uplink signal radio section 916 to duplexer 911.

Duplexer 913 outputs the downlink signal or the pilot signal input from duplexer 911 to downlink signal radio section 917. Duplexer 913 outputs an uplink signal input from uplink signal radio section 918 to duplexer 911.

Duplexer 914 outputs the downlink signal or the pilot signal input from duplexer 910 to downlink signal radio section 919. Duplexer 914 outputs an uplink signal input from uplink signal radio section 920 to duplexer 910.

Downlink signal radio section 915 performs radio processing to the downlink signal or the pilot signal input from duplexer 912 to output the signal to duplexer 921. At this time, uplink signal radio section 915, by using a clock signal input from PLL circuit 938, up-converts a 500-MHz downlink signal or a 500-MHz pilot signal into a 2-GHz downlink signal or a 2-GHz pilot signal. Downlink signal radio section 915, under the control of control section 937, adjusts a level of the downlink signal or the pilot signal. A detailed configuration of downlink signal radio section 915 will be described later.

Uplink signal radio section 916 performs radio processing to the uplink signal input from duplexer 921 to output the signal to duplexer 912. At this time, uplink signal radio section 916, by using a clock signal input from PLL circuit 938, down-converts a 2-GHz uplink signal into a 400-MHz uplink signal. Uplink signal radio section 916, under the control of control section 937, adjusts a level of the uplink signal. A detailed configuration of uplink signal radio section 916 will be described later.

Downlink signal radio section 917 performs radio processing to a downlink signal or a pilot signal input from duplexer 913 to duplexer 922. More specifically, downlink signal radio section 917 amplifies the downlink signal or the pilot signal input from duplexer 913 to output the signal to duplexer 922.

Uplink signal radio section 918 performs radio processing to the uplink signal input from duplexer 922 to output the signal to duplexer 913. More specifically, uplink signal radio section 918 amplifies the uplink signal input from duplexer 922 to the signal to duplexer 913.

Downlink signal radio section 919 performs radio processing to the downlink signal or the pilot signal input from duplexer 914 to output the signal to distributor 923. More specifically, downlink signal radio section 919 amplifies the downlink signal or the pilot signal input from duplexer 914 to output the signal to distributor 923.

Uplink signal radio section 920 performs radio processing to the uplink signal input from distributor 924 to output the signal duplexer 914. More specifically, uplink signal radio section 920 amplifies the uplink signal input from distributor 924 to output the signal to duplexer 914.

Duplexer 921 outputs a downlink signal or a pilot signal input from downlink signal radio section 915 to distributor 929. Duplexer 921 outputs the uplink signal input from distributor 929 to the signal uplink signal radio section 916.

Duplexer 922 outputs a downlink signal or a pilot signal input from downlink signal radio section 917 to coupler 932. Duplexer 922 outputs an uplink signal input from coupler 932 to uplink signal radio section 918.

Distributor 923 outputs a downlink signal or a pilot signal input from downlink signal radio section 919 to duplexer 925 and outputs the signal to amplifier 926.

Distributor 924 couples an uplink signal input from duplexer 925 and an uplink signal input from amplifier 927 to output the resultant signal to uplink signal radio section 920.

Duplexer 925 outputs the downlink signal or the pilot signal input from distributor 923 to coupler 932. Duplexer 925 outputs an uplink signal input from coupler 932 to distributor 924.

Amplifier 926 amplifies the downlink signal or the pilot signal input from distributor 923 to output the signal to duplexer 928.

Amplifier 927 amplifies the uplink signal input from duplexer 928 to output the signal to distributor 924.

Duplexer 928 outputs the downlink signal or the pilot signal input from amplifier 926 to distributor 930. Duplexer 928 outputs an uplink signal input from distributor 930 to amplifier 927.

Distributor 929 outputs the downlink signal input from duplexer 921 to switching section 931. Distributor 929 outputs the pilot signal input from duplexer 921 to level detecting section 936. Distributor 929 outputs an uplink signal input from switching section 931 to duplexer 921.

Distributor 930 outputs the downlink signal input from duplexer 928 to switching unit 933. Distributor 930 outputs the pilot signal input from duplexer 928 to level detecting section 936. Distributor 930 outputs an uplink signal input from switching unit 933 to duplexer 928.

Switching section 931 outputs the downlink signal input from distributor 929 to antenna 934. Switching section 931 outputs the uplink signal input from antenna 934 to distributor 929. Switching section 931, in the measurement mode, does not output the pilot signal input from pilot signal generating section 103 to antenna 934. With this operation, antenna 934 is physically separated.

Coupler 932 couples the downlink signal or the pilot signal input from duplexer 922 with the downlink signal or the pilot signal input from duplexer 925 to transmit the resultant signal slave device 803. Coupler 932 outputs the input uplink signal input from slave device 803 to duplexer 922 and duplexer 925.

Switching unit 933 outputs the downlink signal input from distributor 930 to antenna 935. Switching unit 933 outputs an uplink signal input from antenna 935 to distributor 930. Switching unit 933, in the measurement mode, does not output the pilot signal input from pilot signal generating section 103 to antenna 935. With this operation, antenna 935 is physically separated.

Antenna 934 is an antenna to perform MIMO transmission and transmits the downlink signal input from switching section 931 to a communication terminal apparatus (not shown) located in a communicable area of slave device 802. Antenna 934 receives an uplink signal transmitted from the communication terminal apparatus (not shown) located in the communicable area of slave device 802 to output the received uplink signal to switching section 931.

Antenna 935 is an antenna to perform MIMO transmission and transmits the downlink signal input from switching unit 933 to a communication terminal apparatus (not shown) located in a communicable area of slave device 802. Antenna 935 receives an uplink signal transmitted from the communication terminal apparatus (not shown) located in the communicable area of slave device 802 to output the received uplink signal to switching section 933.

Level detecting section 936 detects a level of the pilot signal input from distributor 929 or the pilot signal input from distributor 930. Level detecting section 936 outputs a detection result of the detected level to control unit 937. At this time, when level detecting section 936 detects matching between a pattern of time transient of the signal level and a known specific pattern, level detecting section 936 determines that a pilot signal is received, and then detects a level within a predetermined period of time.

Control unit 937, on the basis of the detection result input from level detecting section 936, adjusts a level of a signal in downlink signal radio section 915, uplink signal radio section 916 downlink signal radio section 917, uplink signal radio section 918, downlink signal radio section 919, or uplink signal radio section 920. More specifically, control unit 937 calculate a loss of amplitude on the basis of differences between levels of pilot signals transmitted through downlink signal radio section 109, downlink signal radio section 901, and downlink signal radio section 915 and a preset reference value to determine an adjustment value depending on the calculated loss of amplitude. The control section 937, on the basis of the determined adjustment value, adjusts the level of the signal in downlink signal radio section 915 and the level of the uplink signal in uplink signal radio section 916. Control unit 937 calculates a loss of amplitude on the basis of differences between levels of pilot signals transmitted through downlink signal radio section 111, downlink signal radio section 126, and downlink signal radio section 919 to determine an adjustment value depending on the calculated loss of amplitude. Control unit 937 adjusts the level of the signal in downlink signal radio section 919 and the level of the uplink signal in uplink signal radio section 920.

PLL circuit 938, by using a clock signal supplied from local oscillator 138 through coaxial wire 810, generates a clock signal having a predetermined frequency. PLL circuit 938 outputs the generated clock signal to downlink signal radio section 915 and uplink signal radio section 916.

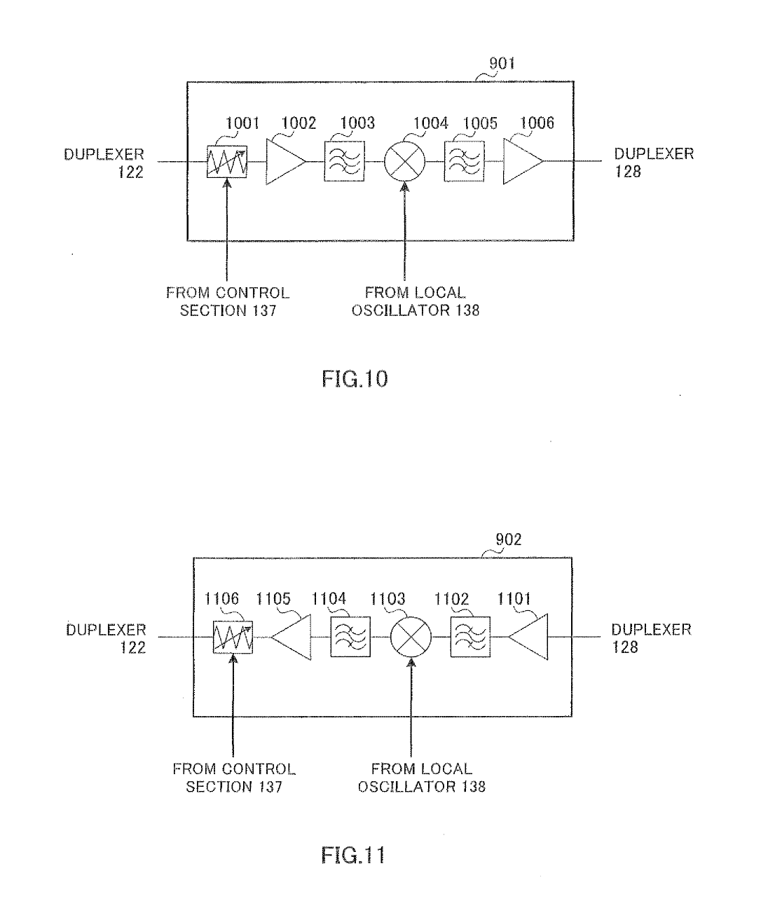

A configuration of downlink signal radio section 901 will be described below with reference to FIG. 10. FIG. 10 shows the configuration of downlink signal radio section 901.

Downlink signal radio section 901 has variable attenuator 1001, amplifier 1002, filter 1003, mixer 1004, filter 1005, and amplifier 1006. Downlink signal radio section 901 has a configuration in which variable attenuator 1001, amplifier 1002, filter 1003, mixer 1004, filter 1005, and amplifier 1006 are connected in series with each other, in the order named.

Variable attenuator 1001 attenuates the level of a downlink signal or a pilot signal input from duplexer 122 to the adjustment value determined in control section 137. Variable attenuator 1001 outputs the downlink signal or the pilot signal having an attenuated level to amplifier 1002.

Amplifier 1002 amplifies the downlink signal or the pilot signal input from variable attenuator 1001 to output the signal to filter 1003.

Filter 1003 is, for example, a saw filter or an LC filter, and limits a bandwidth of the downlink signal or the pilot signal input from amplifier 1002 to output the signal to mixer 1004.

Mixer 1004, based on a clock signal input from local oscillator 138, performs frequency conversion of the downlink signal or the pilot signal input from filter 1003. More specifically, mixer 1004 mixes the clock signal input from local oscillator 138 with the downlink signal or the pilot signal input from filter 1003 to down-convert a 2-GHz downlink signal or a 2-GHz pilot signal into a 500-MHz downlink signal or a 500-MHz pilot signal. Mixer 1004 outputs the down-converted downlink signal or the down-converted pilot signal to filter 1005.

Filter 1005 is, for example, a saw filter, and has a attenuation characteristic larger than that of filter 1003. Filter 1005 limits a bandwidth of the downlink signal or the pilot signal input from mixer 1004 to output the signal to amplifier 1006.

Amplifier 1006 amplifies the downlink signal or the pilot signal input from filter 1005 to output the signal to duplexer 128.

A configuration of uplink signal radio section 902 will be described below with reference to FIG. 11. FIG. 11 shows a configuration of uplink signal radio section 902.

Uplink signal radio section 902 has amplifier 1101, filter 1102, mixer 1103, filter 1104, amplifier 1105, and variable attenuator 1106. Uplink signal radio section 902 has a configuration in which, from the upstream side to the downstream side, amplifier 1101, filter 1102, mixer 1103, filter 1104, amplifier 1105, and variable attenuator 1106 are connected in series with each other, in the order named.

Amplifier 1101 amplifies an uplink signal input from duplexer 128 to output the signal filter 1102.

Filter 1102 is, for example, a saw filter, and limits a bandwidth of the uplink signal input from amplifier 1101 to output the signal to mixer 1103.

Mixer 1103, based on a clock signal input from local oscillator 138, performs frequency conversion of the uplink signal input from filter 1102. More specifically, mixer 1103 mixes the clock signal input from local oscillator 138 with the uplink signal input from filter 1102 to up-convert a 400-MHz uplink signal into a 2-GHz uplink signal. Mixer 1103 outputs the up-converted uplink signal to filter 1104.

Filter 1104 is, for example, a saw filter or an LC filter, and has lower attenuation characteristics than filter 1102. Filter 1104 limits a bandwidth of the uplink signal input from mixer 1103 to output the signal to amplifier 1105.

Amplifier 1105 amplifies the uplink signal input from filter 1104 to output the signal to variable attenuator 1106.

Variable attenuator 1106 attenuates the level of the uplink signal input from amplifier 1105 to the adjustment value determined in control section 137. Variable attenuator 1106 outputs the uplink signal having an attenuated level to duplexer 122.

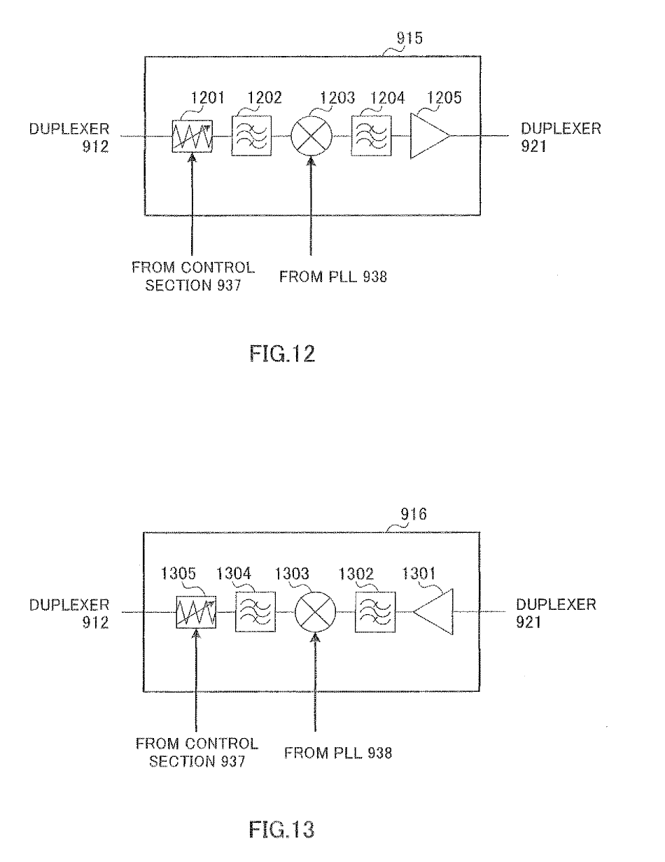

A configuration of downlink signal radio section 915 will be described below with reference to FIG. 12. FIG. 12 shows the configuration of downlink signal radio section 915.

Downlink signal radio section 915 has variable attenuator 1201, filter 1202, mixer 1203, filter 1204, and amplifier 1205. Downlink signal radio section 915 has a configuration in which, from the upstream side to the downstream side, variable attenuator 1201, filter 1202, mixer 1203, filter 1204, and amplifier 1205 are connected in series with each other, in the order named.

Variable attenuator 1201 attenuates the level of a downlink signal or a pilot signal input from duplexer 912 to the adjustment value determined in control section 937. Variable attenuator 1201 outputs the downlink signal or the pilot signal having an attenuated level to amplifier 1202.

Filter 1202 is, for example, a saw filter. Filter 1202 is a filter having attenuation characteristics equal to or greater than a predetermined value (for example, 20 dB or more)—that is, a filter having significant attenuation characteristics—and has significant influence on signal delay and phase. Filter 1202 limits a bandwidth of the downlink signal or the pilot signal input from amplifier 1201 to output the signal to mixer 1203.

Mixer 1203, based on a clock signal input from PLL circuit 938, performs frequency conversion of the downlink signal or the pilot signal input from filter 1204. More specifically, mixer 1203 mixes the clock signal input from PLL circuit 938 with the downlink signal or the pilot signal input from filter 1202 to up-convert a 500-MHz downlink signal or a 500-MHz pilot signal into a 2-GHz downlink signal or a 2-GHz pilot signal. Mixer 1203 outputs the down-converted downlink signal or the up-converted pilot signal to filter 1204.

Filter 1204 is, for example, a saw filter or an LC filter, and has lower attenuation characteristics than filter 1202. Filter 1204 limits a bandwidth of the downlink signal or the pilot signal input from mixer 1203 to output the signal to amplifier 1205.

Amplifier 1205 amplifies the downlink signal or the pilot signal input from filter 1204 to output the signal to duplexer 921.

A configuration of uplink signal radio section 916 will be described below with reference to FIG. 13. FIG. 13 shows the configuration of uplink signal radio section 916.

Uplink signal radio section 916 has amplifier 1301, filter 1302, mixer 1303, filter 1304, and variable attenuator 1305. Uplink signal radio section 916 has a configuration in which, from the upstream side to the downstream side, amplifier 1301, filter 1302, mixer 1303, filter 1304, and variable attenuator 1305 are connected in series with each other, in the order named.

Amplifier 1301 amplifies an uplink signal input from duplexer 921 to output the signal to filter 1302.

Filter 1302 is, for example, a saw filter or an LC filter, and limits a bandwidth of the uplink signal input from amplifier 1301 to output the signal to mixer 1303.

Mixer 1303, based on a clock signal input from PLL circuit 938, performs frequency conversion of the uplink signal input from filter 1302. More specifically, mixer 1303 mixes the clock signal input from PLL circuit 938 with the uplink signal input from filter 1302 to down-convert a 2-GHz uplink signal into a 400-MHz uplink signal. Mixer 1303 outputs the down-converted uplink signal to filter 1304.

Filter 1304 is, for example, a saw filter. Filter 1304 is a filter having attenuation characteristics equal to or greater than a predetermined value (for example, 20 dB or more)—that is, a filter having significant attenuation characteristics—and has greater attenuation characteristics than filter 1302. Therefore, filter 1304 has significant influence upon signal delay and phase. The filter 1304 limits a bandwidth of the uplink signal input from mixer 1303 to output the signal to variable attenuator 1305.

Variable attenuator 1305 attenuates the level of an uplink signal input from duplexer 1304 to the adjustment value determined in control section 937. Variable attenuator 1305 outputs the uplink signal having an attenuated level to amplifier 912.

Since each of configurations of slave devices 803 to 807 are the same as the configuration of slave device 802, a description thereof will be omitted.

A signal received by antenna 101 is subjected to bandwidth limitation twice in filter 1005 having significant attenuation characteristics and in filter 1202 having significant attenuation characteristics. A signal received by antenna 102 is subjected to bandwidth limitation twice in filter 204 having significant attenuation characteristics and in filter 603 having significant attenuation characteristics. Therefore, the signal received by antenna 101 and the signal received by antenna 102 are subjected to bandwidth limitation the same number of times in the filters each having significant attenuation characteristics. An uplink signal is also subjected to bandwidth limitation the same number of times in a filter having significant attenuation characteristics.

Radio relay system 800 having the above configuration, in order to provide a radio relay apparatus that can support an MIMO system without changing a wiring of an already installed radio relay apparatus that does not support the MIMO system, includes a configuration in which a frequency of a signal received by antenna 102 is converted into a different frequency from the frequency of a signal received by antenna 101 to multiplex the frequency of the signal received by antenna 101 and the frequency of the signal received by antenna 102. Radio relay apparatus 800, in order to prevent signals input from the antennas from being considerably delayed and to prevent a delay difference from being generated between the signals input from the antennas, includes a configuration in which high-frequency signals input from the antennas are processed without being changed in frequency. Radio relay apparatus 800, in order to prevent a difference delay from being generated between the signals input from the antennas, includes a configuration in which a filter that considerably delays the signals received by the plurality of antennas at high frequencies—that is, a filter having significant attenuation characteristics—is configured by a filter of one type, and the signals are subjected to bandwidth limitation the same number of times in the filter. Radio relay apparatus 800, in order to prevent a signal level difference between the signals input from the antennas, includes a configuration including a variable attenuator. Radio relay apparatus 800, in order to prevent a phase difference between the signals (modulated waves) input from the antennas, includes a configuration in which a filter that causes a large delay at a high frequency is configured by a filter of one type, and the signals are subjected to bandwidth limitation the same number of times in the filter having significant attenuation characteristics.

In this manner, in addition to the effect of Embodiment 1 described above, a slave device that can support the MIMO system can be installed without changing an existing wiring, and the cost of installation of the slave device that can support the MIMO system can be suppressed. According to the embodiment, when a pilot signal is supplied to a switching section arranged immediately below an antenna of a first radio apparatus to adjust a level, amplitude attenuations by processes subsequent to the process for a portion immediately below the antenna arranged in the first radio apparatus can be adjusted at once in the slave devices. For this reason, an adjusting operation can be simplified, and independent adjusting circuits need not be arranged in the slave devices. Therefore, a circuit scale can be reduced. According to the embodiment, when signals received by a plurality of antennas are subjected to bandwidth limitation the same number of times in a filter having significant attenuation characteristics to prevent a long delay time from being generated between the signals and to prevent a large phase difference between the signals. When a signal for the MIMO system is relayed to the slave device, the signal can be prevented from being deteriorated.

In Embodiment 1 and Embodiment 2 described above, a downlink frequency is converted from 2 GHz to 500 MHz, and an uplink frequency is converted from 2 GHz to 400 MHz. However, the present invention is not limited to the above embodiments, 2 GHz can be down-converted into an arbitrary frequency except for 500 MHz, 2 GHz can be up-converted into an arbitrary frequency except for 400 MHz.

The disclosure of Japanese Patent Application No. 2009-13052, filed on Jan. 23, 2009, including the specification, drawings and abstract, is incorporated herein by reference in its entirety.

### INDUSTRIAL APPLICABILITY

A radio relay apparatus and a radio relay system according to the present invention suitably support an MIMO system without especially changing an existing wiring.

1-9. (canceled)

10. A radio relay apparatus comprising a first radio apparatus and a second radio apparatus connected to the first radio apparatus with a first coaxial wire, a signal in multiple input multiple output communication being relayed by the first radio apparatus and the second radio apparatus, wherein:
the first radio apparatus includes:
a first antenna;
a second antenna;
a first radio section that performs first radio processing to a first signal received by the first antenna in a normal mode and performs the first radio processing to a first pilot signal having a predetermined frequency in a measurement mode;
a second radio section that performs second radio processing including frequency conversion into a different frequency from the frequency of the first signal to a second signal received by the second antenna in the normal mode and performs the second radio processing to a second pilot signal having a predetermined frequency in the measurement mode; and
a first output section that performs frequency division multiplexing of the first signal that is subjected to the first radio processing and the second signal that is subjected to the second radio processing in the normal mode to transmit the resulting signal to the second radio apparatus by using the same first coaxial wire and performs frequency division multiplexing of the first pilot that is subjected to the first radio processing and the second pilot signal that is subjected to the second radio processing in the measurement mode to transmit the resulting signal to the second radio apparatus by using the same first coaxial wire; and
the second radio apparatus includes:
a third radio section that performs third radio processing to a first signal transmitted from the first radio apparatus through the first coaxial wire in the normal mode and performs the third radio processing to the first pilot signal transmitted from the first radio apparatus through the first coaxial wire in the measurement mode;
a fourth radio section that performs fourth radio processing to the second signal transmitted from the second radio apparatus through the first coaxial wire in the normal mode and performs the fourth radio processing to the second pilot signal transmitted from the first radio apparatus through the first coaxial wire in the measurement mode;
a detecting section that detects of a level of the first pilot signal subjected to the third radio processing or the second pilot signal subjected to the fourth radio processing in the measurement mode; and
a control section that controls a gain of the first signal transmitted in the normal mode on the basis of the level of the first pilot signal detected in the measurement mode and controls a gain of the second signal transmitted in the normal mode on the basis of the level of the second pilot signal detected in the measurement mode.

11. The radio relay apparatus according to claim 10, wherein the first signal received by the first antenna and the second signal received by the second antenna are signals transmitted at the same frequency.

12. The radio relay apparatus according to claim 11, wherein the third radio section further converts a frequency of the first signal or the first pilot signal into a frequency equal to the frequency of the second signal or the second pilot signal output from the fourth radio section.

13. The radio relay apparatus according to claim 10, wherein the second radio section, in the second radio processing, performs bandwidth limitation of the second signal or the second pilot signal that is frequency-converted.

14. The radio relay apparatus according to claim 10, wherein the second radio apparatus makes the number of times of bandwidth limitation of the first signal or the first pilot signal by using a filter having attenuation characteristics equal to or greater than a predetermined value in the first radio processing and the third radio processing equal to the number of times of bandwidth limitation of the second signal or the second pilot signal by using a filter having attenuation characteristics equal to or greater than a predetermined value in the second radio processing and the fourth radio processing.

15. The radio relay apparatus according to claim 10, wherein:
the second radio apparatus includes a local oscillator that generates a clock signal;
the second radio section, in the second radio processing, performs a frequency conversion process to the second signal or the second pilot signal received by the second antenna based on the clock signal supplied from the local oscillator;
a third radio section, in the third radio processing, performs frequency conversion to the first signal or the first pilot signal transmitted from the first radio apparatus through the first coaxial wire based on the clock signal supplied from the local oscillator; and
the fourth radio section, in the fourth radio processing, performs frequency conversion to the second signal or the second pilot signal transmitted from the first radio apparatus through the first coaxial wire based on the clock signal supplied from the local oscillator.

16. The radio relay apparatus according to claim 10, wherein:
the first radio apparatus further includes a local oscillator that generates a clock signal; and
in the second radio apparatus:
the second radio section, in the second radio processing, performs frequency conversion to the second signal or the second pilot signal received by the second antenna based on the clock signal supplied from the local oscillator;
the third radio section, in the third radio processing, performs frequency conversion to the first signal or the first pilot signal transmitted from the first radio apparatus through the first coaxial wire based on the clock signal supplied from the local oscillator; and
the fourth radio section, in the fourth radio processing, performs frequency conversion to the second signal or the second pilot signal transmitted from the first radio apparatus through the first coaxial wire based on the clock signal supplied from the local oscillator; and
the clock signal, during an operation of the second radio apparatus, is supplied from the first radio apparatus to the second radio apparatus through the first coaxial wire together with the first signal or the first pilot signal subjected to the first radio processing and the second signal or the second pilot signal subjected to the second radio processing.

17. A radio relay system comprising:
the radio relay apparatus according to claim 10; and
at least one slave device that is connected to the radio relay apparatus with a second coaxial wire to expand a communicable area of the radio relay apparatus, a signal in multiple input multiple output communication being relayed by the radio relay apparatus and the slave device, wherein the second radio apparatus further includes:
a second output section that performs frequency division multiplexing of the first signal that is subjected to the third radio processing and the second signal that is subjected to the fourth radio processing to transmit the resulting signal to the slave device through the second coaxial wire; and
a fourth radio section, in the fourth radio processing in the normal mode, converts a frequency of the second signal into a different frequency from the frequency of the first signal after the frequency conversion in the third radio section.
